(19) United States
(12) Patent Application Publication
(10) Pub. No.: US 2012/0027611 A1
(43) Pub. Date: Feb. 2, 2012

(54) COMPRESSION MEMBER FOR WIND TURBINE ROTOR BLADES

(75) Inventor: Aaron Yarbrough, Clemson, SC (US)

(73) Assignee: GENERAL ELECTRIC COMPANY, Schenectady, NY (US)

(21) Appl. No.: 13/177,634

(22) Filed: Jul. 7, 2011

(51) Int. Cl. F01D 5/14; B23P 15/02

(52) U.S. Cl. 416/226; 29/889.7

(57) ABSTRACT

A rotor blade for a wind turbine is disclosed. The rotor blade may include a body having a pressure side shell and a suction side shell extending between a leading edge and a trailing edge. A spar member may extend between the pressure and suction side shells. Additionally, a removable compression member may extend between the pressure and suction side shells. The compression member may be formed from a compliant material.

### FIELD OF THE INVENTION

The present subject matter relates generally to wind turbines and, more particularly, to a compression member for a wind turbine rotor blade configured to provide increased buckling resistance during the performance of handling operations on the blade.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

Wind turbine rotor blades are typically manufactured at a location remote to a wind turbine site and, thus, must be subsequently transported to the site. Accordingly, numerous handling operations are performed on a rotor blade between its initial manufacture and its final installation onto a wind turbine. For example, upon molding and assembling of the pressure and suction side panels or shells to form the rotor blade body, a rotor blade is typically lifted from the mold using suitable lifting equipment (e.g., cranes or lifting systems) and moved to a storage facility or other temporary location. Additionally, when it is time to transport the rotor blade to the wind turbine site, the rotor blade must be lifted/moved onto a transporting vehicle and subsequently strapped, tied or otherwise secured to the vehicle for safe transport. Moreover, upon arrival at the wind turbine site, the rotor blade must again be lifted to remove the blade from the transporting vehicle and to also raise the blade to a suitable height for assembly onto the wind turbine.

Given such numerous handling operations, there is a significant opportunity for damage to occur to a rotor blade prior to final assembly onto a wind turbine. For example, it has been found that the pressure and suction side shells of a rotor blade may be subject to instability and/or deflection during lifting of the blade, which can lead to buckling of the pressure side shell and/or the suction side shell. Specifically, the cables, straps and/or other devices typically coupled to the rotor blade during lifting tend to apply a compressive load on the blade (particularly along the pressure side of the blade at the trailing edge), thereby causing one or both of the shells to deflect inwardly and crack. Moreover, the compression straps or other tie-downs used to secure a rotor blade to a transporting vehicle also tend to apply compressive loads on the blade, further increasing the likelihood of blade failures due to buckling.

Accordingly, a compression member that may be installed within a rotor blade to prevent buckling during the performance of handling operations on the blade would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a rotor blade for a wind turbine. The rotor blade may include a body having a pressure side shell and a suction side shell extending between a leading edge and a trailing edge. A spar member may extend between the pressure and suction side shells. Additionally, a removable compression member may extend between the pressure and suction side shells. The compression member may be formed from a compliant material.

In another aspect, the present subject matter discloses a method for providing buckling resistance to a rotor blade during handling of the blade. The method may generally include installing a compression member between a pressure side shell and a suction side shell of the rotor blade prior to performing a handling operation on the rotor blade and removing the compression member from within the rotor blade after the handling operation is completed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine of conventional construction;

FIG. 2 illustrates a perspective view of one embodiment of a rotor blade in accordance with aspects of the present subject matter;

FIG. 3 illustrates a cross-sectional view of the rotor blade shown in FIG. 2 taken along section line 3-3; and

FIG. 4 illustrates a cross-sectional view of another embodiment of a rotor blade in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter discloses a rotor blade having one or more compression members installed therein in order to prevent the blade's panels or shells from deflecting inwardly relative to one another. In several embodiments, the compression members may be removably secured within the rotor blade. As such, the compression member(s) may be designed to provide temporary buckling resistance to the rotor blade during the performance of handling operations on the blade (e.g., lifting operations, transporting of the blade and installation of the blade onto a wind turbine hub).

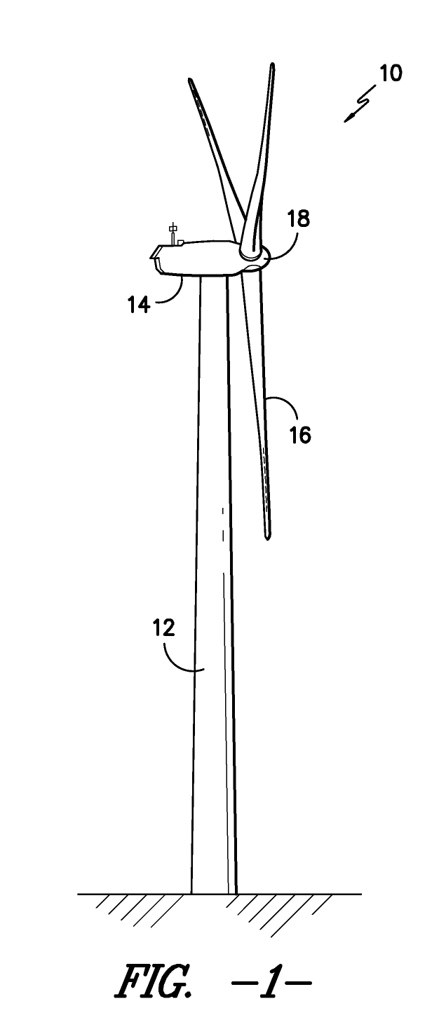

Referring now to the drawings, FIG. 1 illustrates perspective view of a wind turbine 10 of conventional construction. The wind turbine 10 includes a tower 12 with a nacelle 14 mounted thereon. A plurality of rotor blades 16 are mounted to a rotor hub 18, which is, in turn, connected to a main flange that turns a main rotor shaft. The wind turbine power generation and control components are housed within the nacelle 14. It should be appreciated that the wind turbine 10 of FIG. 1 is provided for illustrative purposes only to place the present invention in an exemplary field of use. Thus, one of ordinary skill in the art should appreciate that the invention is not limited to any particular type of wind turbine configuration.

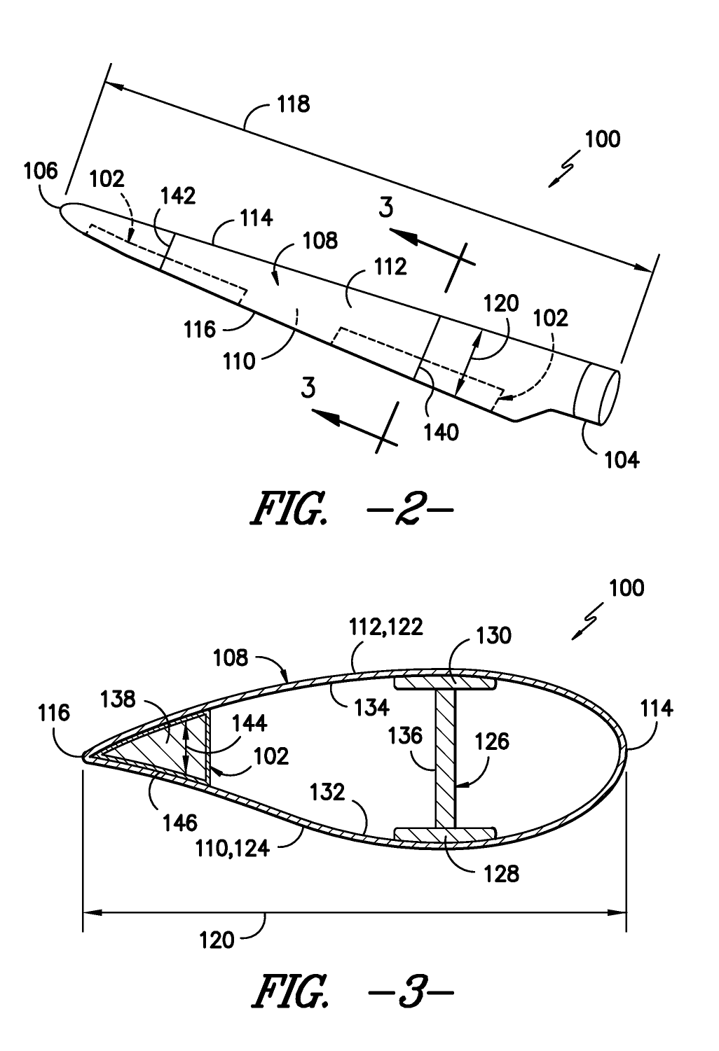

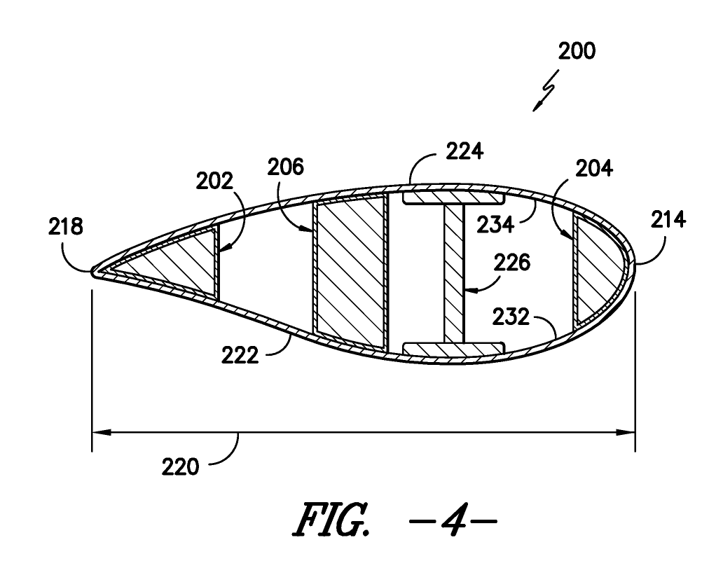

Referring now to FIGS. 2 and 3, one embodiment of a rotor blade 100 having one or more compression members 102 installed therein is illustrated in accordance with aspects of the present subject matter. In particular, FIG. 2 illustrates a perspective view of the rotor blade 100 and FIG. 3 illustrates a cross-sectional view of the rotor blade 100 taken along the sectional line 3-3.

As shown, the rotor blade 100 generally includes a blade root 104 configured to be mounted or otherwise secured to the hub 18 (FIG. 1) of a wind turbine 10 and a blade tip 106 disposed opposite the blade root 104. A body shell 108 of the rotor blade 100 generally extends between the blade root 104 and the blade tip 106. The body shell 108 may generally serve as the outer casing/covering of the rotor blade 100. Additionally, the body shell 108 may define a pressure side 110 and a suction side 112 extending between leading and trailing edges 114, 116 of the rotor blade 100. Further, the rotor blade 100 may have a span 118 defining the total length between the blade root 104 and the blade tip 106 and a chord 120 defining the total length between the leading edge 114 and the trailing edge 116. As is generally understood, the chord 120 may generally vary in length with respect to the span 118 as the rotor blade 100 extends from the blade root 104 to the blade tip 106.

The body shell 108 may generally be configured to define an aerodynamic profile. Thus, in several embodiments, the body shell 108 may define an airfoil shaped cross-section. For example, the body shell 108 may be configured as a symmetrical airfoil or a cambered airfoil. Further, the body shell 108 may also be aeroelastically tailored.

Additionally, in several embodiments, the body shell 108 of the rotor blade 100 may be formed as a single, unitary component. Alternatively, the body shell 108 may be formed from a plurality of shell components. For example, the body shell 106 may be manufactured from a first shell half 122 (FIG. 3) generally defining the pressure side 110 of the rotor blade 100 (hereinafter referred to as the pressure side shell 122) and a second shell half 124 (FIG. 3) generally defining the suction side 112 of the rotor blade 100 (hereinafter referred to as the suction side shell 124), with such shells 122, 124 being secured to one another at the leading and trailing edges 114, 116 of the blade 100.

It should be appreciated that the body shell 108 may generally be formed from any suitable material. For instance, in one embodiment, the body shell 108 may be formed from a laminate composite material, such as a carbon fiber reinforced laminate composite or a glass fiber reinforced laminate composite.

Moreover, as shown in FIG. 3, the rotor blade 100 may also include at least one substantially rigid spar member 126 configured to provide increased stiffness and rigidity to the rotor blade 100. In general, the spar member 124 may include a pair of longitudinally extending spar caps 128, 130 configured to be engaged against opposing inner surfaces 132, 134 of the pressure and suction side shells 122, 124, respectively. The spar member 126 may also include one or more shear webs 136 configured to extend between the spar caps 128, 1230.

As is generally understood, the spar member 126 may be formed from a substantially rigid material in order to control the bending stresses and/or other loads acting on the rotor blade 100 in the generally spanwise direction (a direction parallel to the span 118 of the rotor blade 100) during operation of a wind turbine 10. For example, in several embodiments, the spar member 126 may be formed from the same material as the body shell 108, such as a laminate composite material (e.g., a carbon fiber reinforced laminate composite or a glass fiber reinforced laminate composite).

Referring still to FIGS. 2 and 3, the rotor blade 100 may also include one or more compression members 102 installed between the pressure and suction side shells 122, 124 in order to limit the inward deflection of the shells 122, 124 relative to one another. For example, as shown in the illustrated embodiment, the rotor blade 100 includes two compression members 102 installed within the rotor blade 100. However, in alternative embodiments, the rotor blade 100 may include any other suitable number of compression members 102 installed therein, such as by including a single compression member 102 or by including three or more compression members 102.

As described above, the pressure and/or suction side shells 122, 124 of the rotor blade 100 may be subjected to compressive loading during handling operations that cause the shells 122, 124 to deflect inwardly, which can lead to buckling failures of one or both of the shells 122, 124. For example, the cables, straps and/or other devices utilized to couple the rotor blade 100 to suitable lifting equipment and/or to secure the rotor blade 100 to a suitable transporting vehicle tend to apply compressive loads on the blade 100, thereby causing one or both of the shells 122, 124 to deflect inwardly. Thus is particularly true for the pressure side shell 122 in the area of the trailing edge 116. However, by installing the disclosed compression members 102 between the pressure and suction side shells 122, 124 during handling of the rotor blade 100, the compression members 102 may provide sufficient buckling resistance to the blade 100 in order to prevent cracking and/or any other failures that may otherwise occur due to deflection of the shells 122, 124.

In general, the disclosed compression members 102 may be formed from any suitable compliant material 138 that is configured to limit the inward deflection of the pressure and suction side shells 122, 124 when the compression members 102 are installed with the rotor blade 100. As used herein, the term “compliant material” generally refers to any material that is less rigid than the structural material used to form the spar member 126. For example, in several embodiments, the Young's Modulus of the compliant material 138 may be less than about 50% of the Young's Modulus of any suitable carbon fiber or glass fiber reinforced laminate composite that may be used to manufacture the spar member 126, such as less than about 25% of the Young's Modulus of any suitable carbon fiber or glass fiber reinforced laminate composite or less than about 10% of the Young's Modulus of any suitable carbon fiber or glass fiber reinforced laminate composite and all other subranges therebetween.

As such, it should be appreciated that the compliant material 138 may comprise numerous different semi-rigid, compressible and/or deformable materials. For example, in several embodiments, suitable compliant materials 138 may include various foam materials including, but not limited to, polystyrene foams (e.g., expanded polystyrene foams), polyurethane foams, foam rubber/resin-based foams and various other open cell and closed cell foams. Additionally, suitable compliant materials 138 may include core materials, such as balsa wood, cork and the like. Moreover, suitable compliant materials 138 may include various other semi-rigid, compressible and/or deformable materials, such as a compressible volume of one or more materials (e.g., a hay bale). It should also be appreciated that, by utilizing one or more lightweight compliant materials 138 to form the compression members 102 (e.g., a foam material or a core material), an increased buckling resistance may be provided to the rotor blade 100 without substantially increasing the overall weight of the blade 100.

As shown in the illustrated embodiment, each compression member 102 may generally be dimensioned so as to define a cross-sectional area that is less than the local cross-sectional area defined by the body shell 108 (i.e., the cross-sectional area defined between the inner surfaces 132, 134 of the pressure and suction side shells 122, 124 at the particular cross-sectional location along the span 118 at which the compression member 102 is installed). For example, in several embodiments, the cross-sectional area of each compression member 102 may be equal to less than about 50% of the local cross-sectional area defined by the body shell 108, such as less than about 40% of the local cross-sectional area or less than about 30% of the local cross-sectional area or less than about 20% of the local cross-sectional area or less than about 10% of the local cross-sectional area and all other subranges therebetween. It should be appreciated that, by dimensioning each compression member 102 so that it only occupies a portion of the local cross-sectional area, the compression members 102 may provide localized buckling resistance to specific areas of the rotor blade 100.

Moreover, each compression member 102 may generally be installed between the pressure and suction side shells 122, 124 at any suitable location along the chord 120 of the rotor blade 100. For example, as shown in the illustrated embodiment, the compression members 102 are installed within the rotor blade 100 so as to extend between the inner surfaces 132, 134 of the pressure and suction side shells 122, 124 at a location generally adjacent to the trailing edge 116 of the body shell 108. As such, the compression members 102 may prevent localized inward deflection of the shells 122, 124 at the trailing edge 116. However, as will be discussed below, the compression members 102 may also be configured to extend between the inner surfaces 132, 134 of the pressure and suction side shells 122, 124 at any other suitable location along the length of the chord 120, such as at a location generally adjacent to the leading edge 114 of the body shell 108 and/or at a location generally adjacent to the spar member 126.

It should be appreciated that the shape of each compression member 102 may generally vary depending on the location at which the compression member 102 is installed between the pressure and suction side shells 122, 124. For example, in several embodiments, the shape of each compression member 102 may generally conform to the shape of the area within the rotor blade 100 occupied by the compression member 102. Thus, as shown in the illustrated embodiment, the compression member 102 may generally have a shape corresponding to the internal shape of the rotor blade 100 at and/or adjacent to the trailing edge 116, such as by configuring a height 144 of the compression member 102 to taper in the direction of the trailing edge 116.

Further, the compression members 102 may be configured to extend longitudinally along any portion of the span 118 of the rotor blade 100. For instance, in one embodiment, each compression member 102 installed within the rotor blade 100 may extend longitudinally along the entire span 118 of the blade 100, such as from generally adjacent the blade root 104 to generally adjacent the blade tip 106. Alternatively, as shown in FIG. 2, each compression member 102 may be configured to extend longitudinally along only a portion of the blade's span 120.

In several embodiments, the compression members 102 may be configured to extend longitudinally within the rotor blade 100 at or adjacent to a lifting point 140, 142 on the blade 100. As used herein, the term “lifting point” generally refers to a point along the span 118 of a rotor blade 100 at which the blade 100 may be coupled to lifting equipment during the performance of a handling operation. For example, when a rotor blade 100 is to be placed onto a transporting vehicle or is to be installed onto a wind turbine hub 18 (FIG. 1), one or more cables, straps and/or other devices are typically coupled to the blade 100 at its center of gravity. Thus, as shown in FIG. 2, in one embodiment, a compression member 102 may be disposed within the rotor blade 100 so as to extend forward and aft of a first lifting point 140 generally defined at the center of gravity of the blade 100. It should be appreciated that the center of gravity of the rotor blade 100 may generally be defined at a location ranging from about 20% to about 40% of the span 118 of the blade 100 (referenced from the blade root 104), such as from about 20% to about 35% of the span 118 or from about 25% to about 40% of the span 118 and all other subranges therebetween. However, in alternative embodiments, it is foreseeable that the center of gravity of the rotor blade 100 may be defined at a location less than about 20% of the span 118 or at a location greater than about 40% of the span 118.

In addition to lifting the rotor blade 100 at its center of gravity, one or more cables, straps and/or other devices are typically coupled to the blade 100 at a more outboard location. Thus, as shown in FIG. 2, a compression member 102 may also be located within the rotor blade 100 so as to extend forward and aft of a second lifting point 142 defined at a location radially outboard from the first lifting point 140. In several embodiments, the second lifting point 142 may generally be defined at a location ranging from about 60% to about 95% of the span 118 of the blade 100 (referenced from the blade root 104), such as from about 70% to about 90% of the span 118 or from about 75% to about 85% of the span 118 and all other subranges therebetween. However, in alternative embodiments, it is foreseeable that the second lifting point 142 may be defined at a location less than about 60% of the span 118 or greater than about 95% of the span 118.

It should be appreciated that the rotor blade 100 may generally include any number of lifting points and, thus, need not be limited to the two lifting points 140, 142 illustrated herein. For instance, in one embodiment, three or more lifting points may be defined along the span 118 of the rotor blade 100. Additionally, it should be appreciated that the rotor blade 100 need not include a separate compression member 102 disposed at or adjacent to each lifting point 140, 142 as shown in the illustrated embodiment. For example, in an alternative embodiment, a single compression member 102 may be configured to extend longitudinally within the rotor blade 100 so as to be disposed at or adjacent to each lifting point 140, 142 defined on the blade 100.

Moreover, in several embodiments of the present subject matter, the compression members 102 may be removably secured between the pressure and suction side shells 122, 124. For example, in one embodiment, the compression members 102 may be configured to be installed within the rotor blade 100 by being pressed between the pressure and suction side shells 122, 124. In particular, the height 144 of each compression member 102 may be chosen to be larger than the distance (not shown) defined between the inner surfaces 132, 134 of the pressure and suction side shells 122, 124 at the location at which the compression member 102 is to be installed within the blade 100. As such, when each compression member 102 is installed within the rotor blade 100, the compressive and/or reactive forces generated by pressing the compression member 102 between the pressure and suction side shells 122, 124 may be sufficient to secure the compression member 102 in place between the shells 122, 124. Alternatively, the compression members 102 may be removably secured between the pressure and suction side shells 122, 124 using any other suitable attachment means known in the art. For example, the compression members 102 may be secured between the shells 122, 124 by using mechanical fasteners (e.g., bolts, screws, pins, brackets and the like) or by using non-permanent adhesives (e.g., thermoplastic adhesives that may be heated to remove any bonding between the compression members 102 and the shells 122, 124).

As indicated above, the compression members 102 may generally be configured to provide buckling resistance during the performance of handling operations on the rotor blade 100. Thus, by removably securing the compression members 102 between the pressure and suction side shells 122, 124, the compression members 102 may serve as temporary support members for the rotor blade 100 that can be quickly and easily removed after any and/or all handling operations have been completed. For example, in one embodiment, it may be desirable to install the compression members 102 within the rotor blade 100 during manufacturing of the blade 100 (e.g., during molding of the pressure and suction side shells 122, 124 or after the body shell 108 has been formed) and then subsequently remove the compression members 102 after the rotor blade 100 has been delivered to the field (e.g., before installation of the rotor blade 100 onto the wind turbine hub 18). Alternatively, it may be desirable to leave the compression members 102 within the rotor blade 100 to provide additional buckling resistance to the blade 100 during operation of the wind turbine 10.

It should be appreciated that the compression members 102 may be removed from the rotor blade 100 after the performance of any and/or all handling operations using any suitable removal means and/or method known in the art. For example, in several embodiments, the rotor blade 100 may be formed from multiple blade segments (not shown), such as by configuring the rotor blade as a two-piece or three-piece construction. In such embodiments, the compression members 102 may be removed before or after assembly of the blade segments used to form the rotor blade 100. For instance, prior to assembly of the blade segments, physical access (e.g., by a service worker, tool, cable and/or any other suitable object) may be gained within the blade segments at the joint end(s) of each segment to remove any compression members 102 installed therein. Additionally, after assembly of the blade segments or in the event that the rotor blade 100 is formed from single pressure and suction side shells 122, 124 extending along the entire span 118 of the blade 100, physical access may be gained within the rotor blade 100 at the blade root 104 or through an access window (not shown) defined through the pressure side shell 122 and/or the suction side shell 124 to facilitate removal of any compression members 102 installed within the blade 100.

It should also be appreciated that, in other embodiments of the present subject matter, the compression members 102 may be configured to be non-removably secured between the pressure and suction side shells 122, 124. For instance, in one embodiment, a permanent adhesive may be utilized to secure the compression members 102 between the pressure and suction side shells 122, 124.

Referring particularly to FIG. 3, in several embodiments, each compression member 102 may also include an outer covering 146 designed to at least partially encase the compliant material 138. In one embodiment, the outer covering 146 may comprise a coating applied to the outer surface of the compliant material 138. For example, the outer covering 146 may comprise a coating formed from a rubber material (e.g., vinyl rubber), a polymer material or any other material that may be applied to the outer surface of the compliant material 138 in order to fully or partially encase such material. Alternatively, the outer covering 146 may comprise an enclosed wrapping or other suitable container configured to encase the compliant material 146. For instance, in one embodiment, the compliant material 146 may be wrapped in a thin plastic film or any other suitable flexible material capable of being wrapped around the compliant material 138. In another embodiment, the compliant material 138 may be encased by a pre-manufactured contained designed to receive and/or surround the compliant material 138.

The outer covering 146 may generally provide a means for containing the compliant material 138 in the event of its failure and/or destruction. Specifically, since the compression member 102 need not be designed to provide permanent, structural support to the rotor blade 100, the compliant material 138 may be configured to fail or otherwise be destroyed during operation of the wind turbine 10. For instance, in embodiments in which the compression members 102 are not removed from the rotor blade 100 prior to its assembly onto the wind turbine 10, the compliant material 138 may be chosen such that it cracks, crushes and/or disintegrates when subjected to the normal operating loads of the turbine 10. Thus, by encasing the compliant material 138 within the outer covering 146, the compliant material 138 may be prevented from being scattered within the rotor blade 100 upon its failure and/or destruction.

Referring now to FIG. 4, there is illustrated a cross-sectional view of another embodiment of a rotor blade 200 having compression members 202, 204, 206 installed therein in accordance with aspects of the present subject matter. Specifically, FIG. 4 illustrates examples of various locations at which the compression members 202, 204, 206 may be installed along the chord 220 of the rotor blade 200. It should be appreciated that the rotor blade 200 and compression members 202, 204, 206 shown in FIG. 4 may generally be configured the same as or similar to the rotor blade 100 and compression members 102 described above with reference to FIGS. 2 and 3.

As indicated above, each compression member 202, 204, 206 may generally be configured to extend between the pressure and suction side shells 222, 224 at any suitable location along the length of the chord 220 of the rotor blade 200. Thus, in addition to having one or more compression members 202 installed at a location generally adjacent to the trailing edge 216 of the blade 200 or as an alternative thereto, the rotor blade 200 may include one or more compression members 204 installed between the pressure and suction side shells 222, 224 at a location generally adjacent to the leading edge 214 of the blade 200. Specifically, as shown in FIG. 4, the compression member(s) 204 may be configured to extend between the inner surfaces 232, 234 of the pressure and suction side shells 222, 224 in order to provide localized buckling resistance at the leading edge 214.

Moreover, in addition to having one or more compression members 202, 204 installed at the leading and/or trailing edges 214, 216 of the blade 200, the rotor blade 200 may include one or more compression members 206 extending between the pressure and suction side shells 222, 224 at a location generally adjacent to the spar member 226. For instance, as shown in the illustrated embodiment, the compression member(s) 206 may be installed within the rotor blade 200 so as to extend between the pressure and suction side shells 222, 224 at a location on the trailing edge side of the spar member 226. However, in another embodiment, the compression member(s) 206 may be installed within the blade 200 at a location on the leading edge side of the spar member 226.

It should be appreciated that the present subject matter is also directed to a method for providing buckling resistance to a rotor blade 100, 200 during handling of the blade 100, 200. In several embodiments, the method may include installing a compression member 102, 202, 204, 206 between the pressure and suction side shells 122, 124, 222, 224 prior to performing a handling operation on the rotor blade 100, 200 and removing the compression member 102, 202, 204, 206 from within the rotor blade 100, 200 after the handling operation is completed. For instance, in one embodiment, the compression member 102, 202, 204, 206 may be removably secured between the pressure and suction side shells 122, 124, 222, 224 prior to performing a handling operation on the rotor blade 100, 200 and then removed prior to the rotor blade 100, 200 being installed onto a wind turbine 10.

It should be appreciated that, in alternative embodiments of the present subject matter, the compression members 102 need not be removed prior to installation of the rotor blade 100 onto the wind turbine 10. For instance, by maintaining the compression members 102 within the rotor blade 100 during operation of the wind turbine 10, the compression members 102 may provide additional support to the rotor blade 100 without a significant increase in the overall weight of the blade 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade for a wind turbine, the rotor blade comprising:
a body including a pressure side shell and a suction side shell extending between a leading edge and a trailing edge;
a spar member extending between the pressure and suction side shells; and
a removable compression member extending between the pressure and suction side shells, the compression member being formed from a compliant material.

2. The rotor blade of claim 1, wherein the compression member defines a cross-sectional area that is equal to less than about 50% of a total cross-sectional area of the body.

3. The rotor blade of claim 1, wherein the compression member extends between the pressure and suction side shells at a location generally adjacent to the trailing edge.

4. The rotor blade of claim 1, wherein the compression member extends between the pressure and suction side shells at a location generally adjacent to the leading edge.

5. The rotor blade of claim 1, wherein the compression member extends between the pressure and suction side shells at a location generally adjacent to the spar member.

6. The rotor blade of claim 6, wherein the compliant material comprises at least one of a foam material and a core material.

7. The rotor blade of claim 1, wherein the compression member comprises an outer covering at least partially encasing the compliant material.

8. The rotor blade of claim 7, wherein the outer covering comprises a coating applied to the compliant material.

9. The rotor blade of claim 1, wherein the compression member extends longitudinally within the body at or adjacent to a lifting point on the rotor blade.

10. The rotor blade of claim 9, wherein the lifting point is defined at a center of gravity of the rotor blade.

11. The rotor blade of claim 10, wherein the center of gravity is defined at a location ranging from about 20% to about 40% of a span of the rotor blade.

12. The rotor blade of claim 9, wherein the lifting point is defined at a location ranging from about 60% to about 95% of a span of the rotor blade

13. The rotor blade of claim 1, further comprising a plurality of compression members extending between the pressure and suction side shells, the plurality compression members being disposed at differing locations along a chord of the rotor blade.

14. The rotor blade of claim 1, further comprising a plurality of compression members extending between the pressure and suction side shells, the plurality compression members being spaced apart from one another along a span of the rotor blade.

15. A method for providing buckling resistance to a rotor blade during handling of the rotor blade, the rotor blade including a pressure side shell and a suction side shell, the method comprising:
installing a compression member between the pressure and suction side shells prior to performing a handling operation on the rotor blade; and
removing the compression member from within the rotor blade after the handling operation is completed.

16. The method of claim 15, wherein installing a compression member between the pressure and suction side shells prior performing a handling operation on the rotor blade comprises removably securing the compression member between the pressure and suction side shells.

17. The method of claim 15, wherein removing the compression member from within the rotor blade after the handling operation is completed comprises removing the compression member before the rotor blade is installed onto a wind turbine.

18. The method of claim 15, wherein the handling operation comprises at least one of a lifting operation and transporting the rotor blade to a wind turbine site.

19. The method of claim 15, wherein the compression member is formed from a compliant material.

20. The method of claim 15, wherein the compression member defines a cross-sectional area that is equal to less than about 50% of a total cross-sectional area defined by the body.
